(19) United States
(12) Patent Application Publication
(10) Pub. No.: US 2005/0186998 A1
(43) Pub. Date: Aug. 25, 2005

(54) Novel digital monograph

(76) Inventor: Leslie P. Haas, Scottsdale, AZ (US)

Correspondence Address: GORDON G. WAGGETT, P.C., 3200 SOUTHWEST FREEWAY, SUITE 2355, HOUSTON, TX, 77027, US

(21) Appl. No.: 11/065,499

(22) Filed: Feb. 24, 2005

Related U.S. Application Data
(60) Provisional application No. 60/547,744, filed on Feb. 25, 2004.

(51) Int. Cl. A63F 13/00

(52) U.S. Cl. 463/1

(57) ABSTRACT

The present invention relates to an interactive digital monograph about, e.g., a person(s) or group of persons comprising: a media for storing digital multimedia information, such as a DVD; collectible, updatable content about the person being stored on such media; and computer programming to launch a browser used to obtain updates of such content from the internet or other computer network. Also disclosed is an interactive, virtual trading card (e.g., DVD format) focusing on one or more sports topics comprising a storage media containing electronically stored multimedia content. The content is updatable, retrievable and displayable/playable by the end user. The DVD trading card preferably is authenticatable, by, e.g., providing unique serial numbers, holograms, and endorsement certifications, internal code creating a unique serial number or other indicia for electronically or otherwise verifying the authenticity of the DVD. A method of providing interactivity in a sports trading card is also disclosed.

### CROSS-REFERENCE TO RELATED APPLICATIONS

This application claims the benefit of the filing date of copending U.S. Provisional Patent Application Ser. No. 60/547,744 filed Feb. 25, 2004, Confirmation No. 2775.

### STATEMENT REGARDING FEDERALLY SPONSORED RESEARCH OR DEVELOPMENT

Not Applicable.

### BACKGROUND OF THE INVENTION

The present invention is generally directed to virtual trading cards. More particularly, the present invention relates to the use of sports digital monographs, or sports DVD trading cards to provide interactive multimedia content relating to sports topics of interest, including, without limitation, information about individual and team sports, sports players, sports teams, sports associations, sports clubs, and sports leagues. The sports of interest can include any individual or team sport, including, by way of example, professional, Olympic and amateur sports of all varieties, such as, baseball, football, soccer, rugby, hockey, volleyball, golf, tennis, motor racing, wrestling, lacrosse, swimming, diving, extreme sports, and the like.

Sports trading cards have been in existence for many years and are popular with fans, sports enthusiasts and collectors of all ages. Sports products marketers that specialize in collectible trading cards, among them Upper Deck, Topps, Fleer/Skybox and Donruss, have been producing and distributing non DVD sports collections for many years. Over the last few years, some of these companies have introduced a collection of interactive CD-ROM trading cards and Elite has been producing and releasing extreme sports CD-ROMs for surfing, skateboarding and biking.

Thus, the original paper form of trading cards have now entered the digital age with traditional card manufacturers now offering CD ROM formatted trading cards. For example, one such CD ROM product is the “PowerDeck™” brand of digital trading cards offered by The Upper Deck Co. LLC (worldwide website of upperdeck.com). The PowerDeck digital player trading cards are provided on a CD that when run, displays a background much like seen on a traditional trading card. The PowerDeck card provides profile information about the player, including action and posed photosyn, video highlights, player statistics, and weblinks to organizations, such as, nfl.com or upperdeck.com. Additionally, The Upper Deck Co. offers paper trading cards called “e|cards” that contain a unique serial identification number. The owner of such an “e|card” can periodically check with the The Upper Deck Co. website to see if such serial number has “evolved” into a more valuable item (such as a discount coupon, autographed version, etc.). The owner of the “e|card” can create through the Upper Deck website, a personal file in which an electronic image of such “e|card(s)” will be stored.

Similarly, the worldwide website of InteractiveTradingCards.com offers a CD ROM trading card format that includes brief video introductions of the players/coaches by such players/coaches, a 360° panoramic view of the sports stadium (field, locker room, outside, inside perspectives), and sponsor advertisements. For example, in the baseball format, when viewing an Interactive Trading Card product on, e.g., a Personal Computer, the screen display depicts a baseball field with players from the team standing in the nine defensive positions. Advertising banners appear to hang from the outfield walls. The viewer can point and click on an individual player to obtain additional information, or can point and click on the advertisement banner for information about products and services of the advertiser. Additionally, such CD might contain a brief narrated slide show, a video message from the General Manager, Coach, player, or mascot, and/or a schedule (with links) to the team's opponents.

Additionally, Major League Baseball Productions, in conjunction with Q Video, provides World Series Highlights DVDs as well as several other products, such as the recently released “Yankee Anthology”. Several individual athlete titles, primarily biographies, have made it into the market including a VHS/DVD about a certain player and an animated DVD about another player, however, to date most of the athlete releases are videogame titles. There are over 1,900 sports related video games available on both the CD-ROM and DVD formats. These games are developed for personal computers and advanced entertainment systems including PlayStation II, Xbox and Nintendo and feature sports such as baseball, football, soccer and golf.

However, much like with the paper trading cards, these CD ROM digital playing cards become quickly dated after they are produced. Furthermore, the user interactivity of such CD ROM digital playing cards is limited to pointing and clicking on certain areas of the screen to see additional content contained on the CD. As such, there exists a need to provide an interactive, digital monograph having updatable content and other features of preferred embodiments of the present invention.

### BRIEF SUMMARY OF THE INVENTION

In a preferred embodiment of the present invention there is disclosed an interactive digital monograph about a person comprising. a media for storing digital multimedia information; collectible content about the person, said content capable of being updated, said content being stored on such media; and computer programming to launch a browser used to obtain updates of such content from the internet. This interactive digital monograph may also comprise a collection of DVDs. In a preferred embodiment, the person may be, e.g., an individual sports personality, an individual sports team, and/or a collection of players or teams within the one or more sports topics.

Another preferred embodiment provides an interactive, virtual trading card focusing on one or more sports topics comprising a storage media containing electronically stored multimedia content about one or more sports players and/or teams of interest or combinations thereof. In this embodiment, the content on the media is preferably retrievable and displayable/playable on a media retrieval and display device and the content is updatable. In a preferred embodiment, the storage media is a DVD format The DVD preferably contains indicia for identifying and verifying the authenticity of the DVD. This indicia for identifying and verifying the authenticity of the DVD can be selected from the group of: unique serial numbers, holograms, and endorsement certifications. Additionally, the DVD preferably contains internal code creating a unique serial number or other indicia for electronically verifying the authenticity of the DVD.

In one preferred embodiment, the interactive trading card DVD also comprises DVD-ROM content providing enhanced interactivity, including, means for updating the content of the DVD such that it remains current or virtual; games (including “teaser” games to try on a promotional, preview basis); useful weblinks and marketing demographic information; and further includes programming compatible with the NVIDIA DVD ROM playback system. Preferably, the interactive trading card DVD-ROM content includes a computer program that will launch a “browser” used to seamlessly pull information from the internet and convert it into a pre-designed “virtual trading card” which can be stored by the end user on a media storage device. The interactive trading card of a preferred embodiment of the present invention may be initially provided in a jewel case. The jewel. case can also contain indicia for identifying and verifying the authenticity of the DVD contained therein. This indicia for identification may be selected from the group of: a unique serial numbers, holograms, and endorsement certifications.

In yet another preferred embodiment of the interactive trading card of the present invention, there is provided an express indication of one or more layers of approval or authentication from the group consisting of: (1) personal endorsements of the trading card from the featured player's (or players) personal approval and (2) endorsement from the applicable professional players' association, and the like.

The interactive trading card invention described herein may be displayed on any number of appropriate display devices, such as Set-Top Box (DVD Player); “X-Box”, “Sony PlayStation”; handheld devices, and the like, or a personal computer having a media reader, such as a DVD-ROM drive.

In a preferred embodiment, the media retrieval and display device has the capabilities of interfacing with a computer network, such as the Internet, and further has the ability to access streaming multimedia content from such network.

The interactive trading card of the present invention preferably includes information about each player or team selected from the following career highlights, stats, exclusive personal interviews hosted by top sports personalities, audio and video clips including rarely seen footage of their pre-big league careers and personal archives, as well as footage from their professional careers, live up-to-date team and player statistics, team scores, player trades, league news letters, localized schedules for teams playing in the user's area and team specific skins for use in customizing the user's browser scheme. In another preferred embodiment, the content of the interactive trading card contains multiregional coding, and multilanguage capabilities to allow playability of the in any region of the world.

The present invention also includes a method of providing interactivity in a sports trading card comprising the following steps: collecting multimedia sports trading card content; storing the content on one or more DVDs; providing these DVD(s) to an end user, periodically updating the multimedia sports content and storing same; and providing access to this updated content to end users. In one embodiment, the updated content is contained on another DVD provided to the end user. In another preferred embodiment, the updated content is stored on one or more content servers that are maintained on a computer network. The end user is preferably provided a browser interface to allow the end user to manually or automatically update the content of the interactive trading card when connected to the network. The browser programming contains necessary protocol and authentication to enable the user to obtain such content manually or automatically. Another preferred embodiment of this method further comprises the step of providing to the end-user a subscription to an authorized web-based content provider to provide such updated content. This subscription service is automatically initiated upon the receipt from the end user of a required enrollment.

Additionally, a preferred embodiment of this method includes the step of generating a series of sports team and athletic player collectible digital audio video display monograph DVD disks wherein each disk includes: (1) a menu of topics of interest, (2) each topic being presented in pictorial, textural, audio and/or video media and (3) an ability to update and enhance the information presented.

### BRIEF DESCRIPTION OF THE SEVERAL VIEWS OF THE DRAWINGS

FIG. 1 shows an overview of the multimedia content provided with respect to a preferred embodiment of the present digital monograph invention.

### DETAILED DESCRIPTION OF THE INVENTION

The present invention provides an exciting new interactive sports DVD product line for sports enthusiasts and collectors, young and old, alike. New opportunities in entertainment programming are now possible due to DVD technology, which enables an enhanced combination of superior audio, video, and interactive capabilities. The Interactive Sports DVDs of the present invention consist, in a preferred embodiment, of an on-going collection of DVDs focused on individual sports players that includes career highlights, stats, exclusive personal interviews hosted by top sports personalities, audio and video clips including rarely seen footage of their pre-big league careers and personal archives, as well as footage from their professional careers. The Interactive Sports DVDs can include “teaser” versions of video games to create cross-promotional opportunities for such companies as EA Sports, Activision, THQ and Sega, to name a few.

The Interactive Sports DVDs of the present invention can be produced as an individual DVD item focusing on e.g., a single player, or as a collection of DVDs focusing on a collection of players. For example, one such collection highlights the legends of a particular sport—those players who are considered to be the greatest in the history of their sport, both domestically and internationally. Other collections of the present invention include the popular players presently playing the game. Yet another preferred collection of the present invention presents information regarding an individual team, including information such as all players on the roster as of opening day, to be released at the beginning of the season. Such team DVD would preferably include multimedia information including spring training video footage, pre-season interviews with players and coaches, off-season activities, field/stadium information and other special footage.

The Interactive Sports DVDs of the present invention are preferably produced with multiregional coding, and multilanguage capabilities to allow playability of the DVD in any region of the world.

In a preferred embodiment of the present invention, there is provided an interactive product containing electronically stored multimedia (audio, video, textual, visual, etc.) content about. one or more sports players and/or teams of interest or combinations thereof. The user of this digital sports monograph product would access the information contained on the product using an appropriate media retrieval and display device, such as a Set-Top Box (DVD Player); “X-Box”, “Sony PlayStation”; handheld devices, and the like, or a personal computer having a media reader, such as a DVD-ROM drive. The media for electronically storing such content is preferably DVD, but other media known in the art could be employed. In these preferred embodiments, the media retrieval and storage device would contain appropriate software and hardware, known in the industry, to view and access such multimedia content.

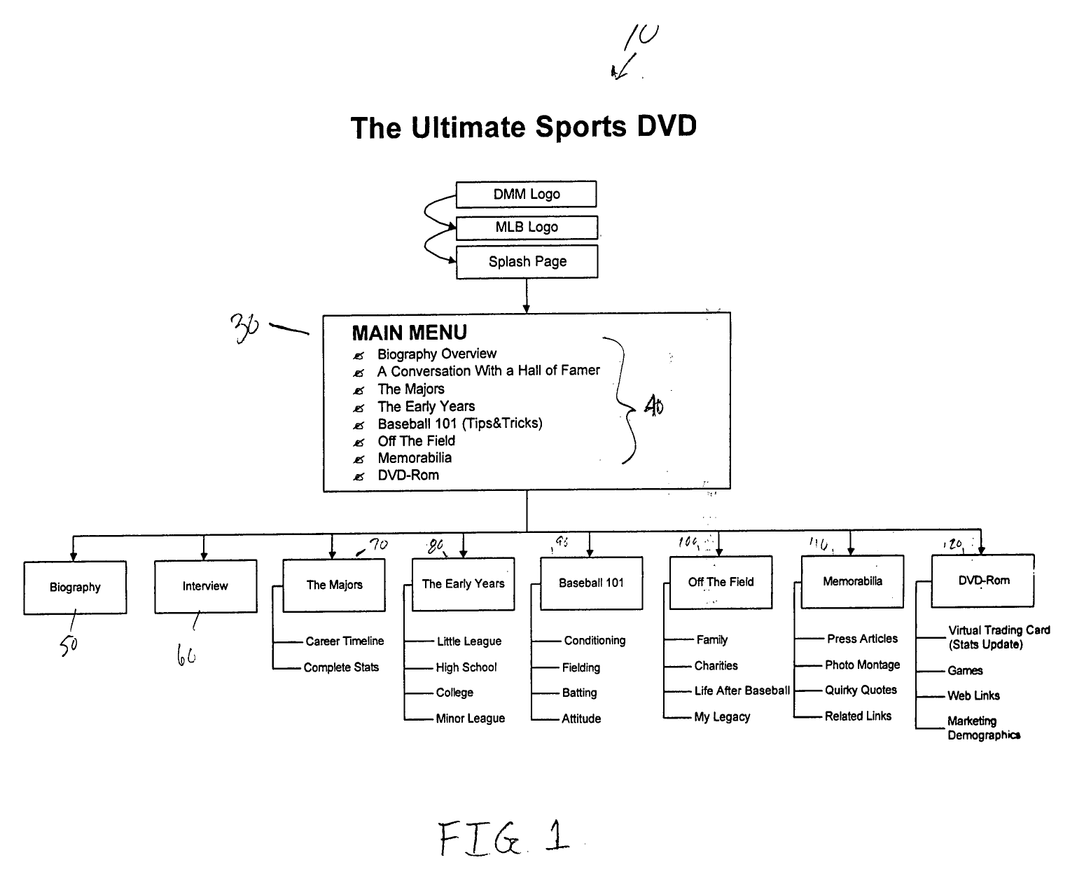

Referring to FIG. 1, there is illustrated an overview of the multimedia content provided with respect to a preferred embodiment of the present invention. In this embodiment, the topic of the multimedia content is centered upon the life and career of a baseball player of interest (e.g., a professional baseball player). In this embodiment, there is provided a DVD 10 (not illustrated) entitled “The Ultimate Sports DVD” or the like. The DVD 10 contains visual and identifying content on its external surface 20, as well as on its packaging 25 (jewel case, etc.)(not illustrated). Such external content can include an identification of the player(s) and team(s) depicted on the DVD, as well as, the source of the DVD, (e.g., Desert Mountain Media), professional endorsements (e.g., the National Baseball League, National Baseball League Players' Association) and advertisement.

Further, the surface of the DVD and/or the jewel case preferably contains indicia for identifying and verifying the authenticity of the DVD, such as, unique serial numbers, holograms, endorsement certifications and the like. Likewise, the DVD itself preferably contains internal code creating a unique serial number or other indicia for electronically verifying the authenticity of the DVD.

Once the DVD is inserted into the player, the viewer will receive content regarding producers, sponsors, etc. in a splash page or the like, and be directed to a main menu 30. In this preferred embodiment, the main menu 30 contains numerous interactive submenus 40 containing multimedia content of interest. For example, the multimedia content may provide information, in various formats (audio-visual, etc.), regarding. the player's or team's biography 50; personal interviews 60; professional career information 70, such as “The Majors” for Major League Baseball, and including the player's career timeline, and complete stats; pre-professional career 80, including information from the early years (Little League, grade school, High School, college, Minor Leagues, etc.); a primer 90 regarding such sport, (e.g., “Baseball 101”) including tips and tricks relating to the athleticism and mindset involved in the sport, such as, fitness/conditioning, fielding, batting, mental attitude; the player's “off the field” or personal life 100 including family, charities, career/life after baseball, and their personal legacy; player or team memorabilia 110, including press articles, a photo montage, interesting or quirky quotes, and related links. Additionally, in one preferred embodiment of the present invention, the DVD contains a video introduction by the featured player(s) introducing the viewer to his/her personal website where, e.g., autographed memorabilia might be purchased.

Additionally, to protect the authenticity of the DVD from a collector's standpoint, each digital sports monograph preferably has a double layer of approval: (1) the featured player's (or players') personal approval and (2) approval from the applicable professional players' association.

In a preferred embodiment of the present invention, there is provided an interactive, updatable digital sports monograph product containing electronically stored multimedia (audio, video, textual, visual, etc.) content about one or more sports players and/or teams of interest or combinations thereof. Referring again to FIG. 1, the DVD 10 also preferably includes DVD-ROM content 120 providing enhanced interactivity, including, means for updating the content of the DVD such that it remains current or virtual; games (including “teaser” games to try on a promotional, preview basis); useful weblinks and marketing demographic information. The user of this updatable, digital sports monograph product would access the DVD-ROM information contained on the product using an appropriate media retrieval and display device, such as a personal computer having a media reader, such as a DVD-ROM drive. The media for electronically storing such content is preferably DVD, but other media known in the industry could be employed. In a preferred embodiment, the media retrieval and display device has the capabilities of interfacing with a computer network, such as the Internet, and further has the ability to access streaming multimedia content from such network. In these preferred embodiments, the media retrieval and storage device would contain appropriate software and hardware, known in the industry, to view and access such multimedia content and computer networks.

The DVD-ROM features are preferably accessed on any Windows/Mac computer with a Direct-Show compatible DVD player/decoder and DVD-ROM drive with the Windows ('98 SE, 2000, ME and XP) or Apple OS X operating systems.

### Browser/Virtual Trading Card

The DVD-ROM content will ideally include a computer program that will launch a “browser” used to pull information from the internet and convert it into a pre-designed “virtual trading card” which will be stored on the user's local PC hard drive. For those users who do not want to store this information on their PC, the updates can also reside strictly in RAM such that the user, while connected to the Internet, will experience the fully updated content without the requirement that such content be permanently stored. This update feature can also be programmed such that it will update whenever the user connects to the Internet, at specific time intervals or when the user tells it to.

This “browser” will seamlessly obtain the most up-to-date information available for the player(s) and/or team(s) contained on the DVD. Some examples of this dynamic, interactive content include, live up-to-date team and player statistics, team scores, player trades, league news letters, localized schedules for teams playing in the user's area and team specific skins for use in customizing the user's browser scheme. Other features could include multimedia applications such as live streaming audio and/or video of games, audio/video highlights of previous games and live inter-active commentaries by the players/teams on the DVD. In addition, Weblinks to sites that host fantasy baseball, sell team memorabilia, contain games and virtually any other content that one can obtain via the internet could be included.

### NVIDIA

In another preferred embodiment, the DVD of the present invention contains programming compatible with the NVIDIA DVD ROM playback system. NVIDIA has a specialized DVD ROM play back system that can be placed on the DVD as a demo. When installed in the commercially available NVDVD players, additional features utilizing functionalities of the NVDVD player such as zooming, dynamic chaptering and slow motion or step through features frame by frame will further enhance the user's enjoyment of the Interactive Sports DVD of the present invention. For example, with the NVIDIA technology, the user can review the baseball bat swing of the featured player in slow motion to visualize coordination, style and execution of swing technique. The Zoom utility can also allow the user to zoom in on other areas of interest, such as a fan in the audience. There are no products yet available in the market utilizing this ROM playback capability.

### Marketing Data

Also via the Internet, marking and demographic data can be obtained from the end-user. Such data could prove to be useful for marketing research.

### Virtual Card Example

Thus, if the Interactive Sports DVD of the present invention was produced in January 2005, and contains information current through the 2004 season, the DVD-ROM program will automatically update the multimedia content that the user sees, so that, for example, if the user is viewing his/her DVD in June 2005, the user will have the most up-to-date stats and other multimedia content available since the production date of the DVD.

### Safeguards

As an added feature to safeguard unauthorized use of the browser software code, the code can contain programming that requires it to look back to the user's original Interactive Sports DVD, such that if the user has previously loaded the software from the DVD, the user will not be able to update the content (via the Internet) without the original DVD in place. Similarly, the user could purchase the original DVD and be prompted, when installing the browser interface from the DVD), to contact the DVD producer (or other applicable host) for password and/or other form of authentication. Once the authentication was obtained, the user could gain access to the updated content.

### Alternate Versions

In an alternative embodiment of the present invention, the Interactive Sports DVD provides only a browser interface programming such that once installed on the user's network ready computer, the user can gain access to all of the multimedia content made available to such user by a third party content provider over such network. In this mode, the browser programming would contain necessary protocol and authentication to enable the user to obtain such content manually or automatically.

As yet another preferred embodiment of the present invention, there is provided a means for an end-user to subscribe to an authorized web-based content provider to provide such updates. This subscription service preferably is automatically initiated upon the receipt from the end user of the required enrollment application, such application potentially requiring receipt of a monetary fee, marketing or demographic data about the user, and the like. The update service content provider(s) would periodically make available for update new informational content relating to the DVD purchased by the user. The user could optionally have the subscription automatically provide such updates, or the user could manually obtain such updates from the content provider.

### Alternate Methodologies

In yet another preferred embodiment of the present invention, there is described a method of providing interactivity in a sports trading card by providing to an end user a DVD as described herein containing multimedia sports content and a browser interface to allow the end user to manually or automatically update the content of such interactive trading card. Updated multimedia information is stored on one or more content servers that are maintained on a computer network, such as the Internet, accessible to the end user. The user can access such updated content on a virtual basis when connected to such network.

In a further preferred embodiment of the present invention, there is described a method for generating a series of sports team and athletic player collectible digital audio video display monograph disks wherein each disk includes: (1) a menu of topics of interest, (2) each topic being presented in pictorial, textural, audio and/or video media and (3) an ability to update and enhance the information presented. In this preferred embodiment, the audio component can preferably contain sounds that are associated with the sport or the player, such as the sound of a crack of a bat hitting a baseball, the stadium crowd noises and music, voices of the players, coaches, announcers, etc. either as background or foreground sound. The textual component can contain written narrative information relevant to the player, team or sport. For example, when featuring the highlights of a player's career, important plays or highlights can be displayed in multimedia formats, such as audio/video clips recording contemporaneously the event or play being highlighted. Further, a written narrative can be provided to set the stage and background for the various important highlights or events of a player's career, such narrative could be produced after-the-fact by the player or other person, and be accompanied by oral narrative and other appropriate sound effects, whether real or contrived, that enhance the presentation of the information.

In another preferred embodiment of the present invention, there is described a method for generating a series of collectible digital audio video display monograph disks wherein each disk includes: (1) a menu of topics of interest, (2) each topic being presented in pictorial, textural, audio and/or video media and (3) an ability to update and enhance the information presented. In a preferred embodiment of this method, the topic of the monograph focuses on one or more sports teams and/or one or more individual athletes.

While the apparatus and methods of this invention have been described in terms of preferred embodiments, it will be apparent to those of skill in the art that variations may be applied to the process described herein without departing from the concept and scope of the invention. All such similar substitutes and modifications apparent to those skilled in the art are deemed to be within the scope and concept of the invention. For example, although the subject of the present invention has been illustrated in the context of Sports, specifically including baseball, the invention could be employed with other sports, and any number of other trading card themes, such as, cartoon/animated characters, action figures, actors/actresses, television, movie and theatre characters, famous historical figures, vehicles, geographical places of interest, world leaders, and the like.

1. An interactive digital monograph about a person comprising
a. a media for storing digital multimedia information;
b. collectible content about the person, said content capable of being updated, said content being stored on such media; and
c. computer programming to launch a browser used to obtain updates of such content from the internet or other computer network.

2. The interactive digital monograph of claim 1 wherein the monograph is a collection of DVDs.

3. The interactive digital monograph of claim 1 wherein the person is selected from the group consisting of: individual sports personalities, individual sports teams, and a collection of players or teams within the one or more sports topics.

4. An interactive, virtual trading card focusing on one or more sports topics comprising a storage media containing electronically stored multimedia content about one or more sports players and/or teams of interest or combinations thereof, said content on said media being retrievable and displayable/playable on a media retrieval and display device; said content being updatable.

5. The interactive trading card of claim 4 wherein the storage media is a DVD format.

6. The interactive trading card of claim 5 wherein the surface of the DVD preferably contains indicia for identifying and verifying the authenticity of the DVD

7. The interactive trading card of claim 6 wherein such indicia for identifying and verifying the authenticity of the DVD is selected from the group of unique serial numbers, holograms, and endorsement certifications; and wherein the DVD contains internal code creating a unique serial number or other indicia for electronically verifying the authenticity of the DVD.

8. The interactive trading card of claim 5 wherein the DVD also comprises DVD-ROM content providing enhanced interactivity, comprising, means for updating the content of the DVD such that it remains current or virtual; games (including “teaser” games to try on a promotional, preview basis); useful weblinks and marketing demographic information; and further programming compatible with the NVIDIA DVD ROM playback system.

9. The interactive trading card of claim 8 wherein the DVD-ROM content includes a computer program capable of launching a “browser” used to seamlessly pull information from the internet or other computer network and convert it into a pre-designed “virtual trading card” which can be stored by the end user on a media storage device

10. The interactive trading card of claim 4 wherein the storage media is initially provided in a jewel case, said jewel case containing indicia for identifying and verifying the authenticity of the DVD provided within said jewel case, wherein such indicia for identification is selected from the group of: a unique serial numbers, holograms, and endorsement certifications.

11. The interactive trading card of claim 4 further comprising an express indication of one or more layers of approval or authentication from the group consisting of: (1) personal endorsements of the trading card from the featured player's (or players') and (2) endorsement from the applicable professional players' association.

12. The interactive trading card of claim 4 wherein the display device is selected from the group consisting of: Set-Top Box (DVD Player); “X-Box”, “Sony PlayStation”; handheld devices, and the like, or a personal computer having a media reader, such as a DVD-ROM drive.

13. The interactive trading card of claim 4 wherein the media retrieval and display device has the capabilities of interfacing with a computer network, such as the Internet, and further has the ability to access streaming multimedia content from such network.

14. The interactive trading card of claim 9 wherein the content includes information about each player or team selected from the following: career highlights, stats, exclusive personal interviews hosted by top sports personalities, audio and video clips including rarely seen footage of their pre-big league careers and personal archives, as well as footage from their professional careers, live up-to-date team and player statistics, team scores, player trades, league news letters, localized schedules for teams playing in the user's area and team specific skins for use in customizing the user's browser scheme.

15. The interactive trading card of claim 4 wherein the content contains multiregional coding, and multilanguage capabilities to allow playability of the in any region of the world.

16. A method of providing interactivity in a sports trading card comprising the following steps:
(a) collecting multimedia sports trading card content;
(b) storing said content on one or more DVDs;
(c) providing to an end user the one or more DVDs containing multimedia sports trading card content,
(d) periodically updating the multimedia sports content and storing same; and
(e) providing access to such updated content to such end user.

17. The method of claim 16 wherein access to the updated content is contained on another DVD provided to the end user.

18. The method of claim 16 wherein said updated content is stored on one or more content servers that are maintained on a computer network; wherein the end user is provided a browser interface to allow the end user to manually or automatically update the content of such interactive trading card when connected to such network; and wherein the browser programming contains necessary protocol and authentication to enable the user to obtain such content manually or automatically.

19. The method of claim 16 further comprising the step of providing to the end-user a subscription to an authorized web-based content provider to provide such updated content; wherein this subscription service is automatically initiated upon the receipt from the end user of a required enrollment.

20. The method of claim 16 further comprising the step of generating a series of sports team and athletic player collectible digital audio video display monograph DVD disks wherein each disk includes: (1) a menu of topics of interest, (2) each topic being presented in pictorial, textural, audio and/or video media and (3) an ability to update and enhance the information presented.
